(19) United States
(12) Patent Application Publication
(10) Pub. No.: US 2008/0178115 A1
(43) Pub. Date: Jul. 24, 2008

(54) DISPLAY CONTROL DEVICE AND COMPUTER-READABLE RECORDING MEDIUM STORING DISPLAY CONTROL PROGRAM

(75) Inventor: Ryutaro Yokota, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/017,870

(22) Filed: Jan. 22, 2008

(30) Foreign Application Priority Data
Jan. 23, 2007 (JP) 2007-013045

(51) Int. Cl. G06F 3/048; G06F 3/033; G06F 3/00

(52) U.S. Cl. 715/784; 715/856; 715/769

(57) ABSTRACT

A display control device controls a display of a cursor and a window on a display screen of the device. The control device includes an instruction receiving section that receives instructions from a pointing device and a position sensor that detects a change to move the cursor. A dragging operation determining section determines based on instructions received by the instruction receiving section whether a dragging operation is performed. A cursor position determining section determines a position of the cursor on the screen based on instructions received by the instruction receiving section. A display controller allows the display device to display a scrolling instruction receiving area which receives from the user an instruction of scrolling a display content of the window when a dragging operation is performed. The display controller allows scrolling of display content of the window when the cursor is within the scrolling instruction receiving area.

### BACKGROUND OF THE INVENTION

1. Field of the Invention

The present invention relates to a display control device and a computer-readable recording medium storing a display control program for supporting a user's operations including a dragging operation and an operation of scrolling a display screen of a display device.

2. Description of the Related Art

Conventionally, as a method for supporting a user who uses an operating system (hereinafter, referred to as OS) such as Windows (registered trademark) or the like to perform operations, such as searching files and mails retained by the OS, a dragging operation with use of a mouse, and a scrolling operation for scrolling a display screen, there has been a method of displaying files in hierarchical layers on a display windows by using a file management software for managing the files and the like.

However, according to this conventional method, even if a user designates a certain file by operating a mouse and, for example, further tries to store the designated file to a folder which is not displayed on a window at this point of time by a dragging operation, it would be difficult to drag and drop the file by performing the dragging operation to the receiving folder which is not displayed. Therefore, since a user requires a long time to perform the operation of storing the designated file to the receiving folder which is not displayed, there is a likelihood that the conventional method deteriorates a user's operability.

### SUMMARY OF THE INVENTION

The present invention was made to solve the above-described problem, and its object is to improve an operability in scrolling a display content of a window at a time when a user performs a drag-and-drop operation.

In summary, a display control device according to an aspect of the present invention includes a display control device which controls a display device to display a cursor and a window on a display screen of the display device, the display control device comprising: an instruction receiving section which receives an instruction outputted from a pointing device having a push-button and a position sensor which detects an operational change to move the cursor; a dragging operation determining section which determines based on an instruction received by the instruction receiving section whether or not a dragging operation is performed by a user; a cursor position determining section which determines a position of the cursor displayed on the display screen based on an instruction received by the instruction receiving section; and a display controller which is operable to allow the display device to display on a peripheral end of the window a scrolling instruction receiving area which receives from the user an instruction of scrolling a display content of the window when the dragging operation determining section determines that a dragging operation is performed, the display controller allowing scrolling of the display content of the window when a position of the cursor determined by the cursor position determining section is within the scrolling instruction receiving area.

These and other objects, features and advantages of the present invention will become more apparent upon reading of the following detailed description along with the accompanied drawings.

### BRIEF DESCRIPTION OF THE DRAWINGS

FIG. 1 is a block diagram showing an example of a configuration of a display control device according to a present embodiment.

FIG. 2 schematically shows an example of an operation pattern storage table.

FIG. 3 is a flowchart illustrating an example of a user support processing executed by the display control device.

FIG. 4 schematically shows an example of a file searching window.

FIG. 5 illustrates a relationship between an operation performed with respect to the file searching window and a determination processing executed by a dragging operation determining section.

FIG. 6 schematically shows an example of the file searching window displayed on a display screen of a display device.

FIG. 7 schematically shows another example of the file searching window displayed on the display screen of the display device.

FIG. 8 schematically shows yet another example of the file searching window displayed on the display screen of the display device.

### DETAILED DESCRIPTION OF THE PREFERRED EMBODIMENTS

Hereinafter, a display control device and a computer-readable recording medium storing a display control program in accordance with an embodiment of the present invention will be described with reference to the drawings. In the descriptions herebelow, a mouse will be described as an example of a pointing device. However, the point device is not limited to this, and it may be a track ball, a touch pad, a touch panel, a stylus pen for use with the touch panel, a track pad, Acu-Point (registered trademark), a track point, a digitizer, or the like.

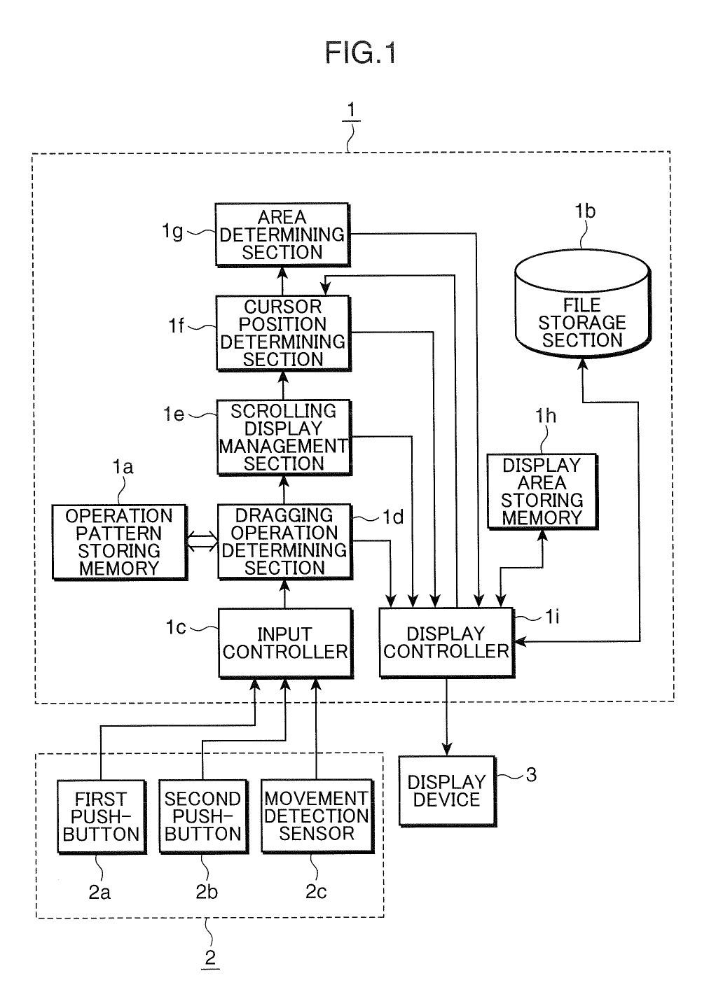

FIG. 1 is a block diagram showing an example of a configuration of a display control device 1 in accordance with the present embodiment. The display control device 1 according to the present embodiment is connected to a mouse 2, which is a pointing device, and a display device 3.

The display control device 1 is realized by a known computer to which a display control program is installed through a recording medium or a communication network. Parts constituting the display control device 1 may be configured with a software or a hardware, or a combination of a software and a hardware.

The mouse 2 includes a first push-button 2a, a second push-button 2b, and a movement detection sensor 2c. When a user performs a pressing operation with respect to a first push-button 2a, the mouse 2 outputs to the display control device 1 an operation signal indicating that the pressing operation is performed with respect to the first push-button 2a of the mouse 2. Further, when the pressing operation is performed with respect to a second push-button 2b, the mouse 2 outputs to the display control device 1 an operation signal indicating that the pressing operation is performed with respect to the second push-button 2b of the mouse 2. It should be understood that the “pressing operation” described above indicates “an operation of holding down a push-button of the pointing device.”

Further, when a user performs a moving operation (an example of an operational change recited in claims of the invention) of the mouse 2 in horizontal direction on a plane (for example, on a desk) where the mouse 2 is placed by the user, the movement detection sensor 2c detects the movement in the horizontal direction and outputs to the display control device 1 a movement detection signal indicating the movement in the horizontal direction.

In the present embodiment, the mouse is described as having two push-buttons. However, it is not intended to limit the number of push-buttons of the mouse 2. The number of push-buttons may be, for example, one, three, or the like.

The display device 3 has a display screen adapted to display a window presenting a display content under a control executed by a display controller 1i which will be described hereinafter. The display content includes a display content which is selected on the display screen through a user's operation of the mouse 2 (for example, a list of hierarchical folders), and a list of hierarchical files and programs.

The display control device 1 will be described more in detail. The display control device 1 includes an operation pattern storing memory 1, a file storage section 1b, an input controller 1c, a dragging operation determining section 1d, a scrolling display management section 1e, a cursor position determining section 1f, an area determining section 1g, a display area storing memory 1h, and a display controller 1i.

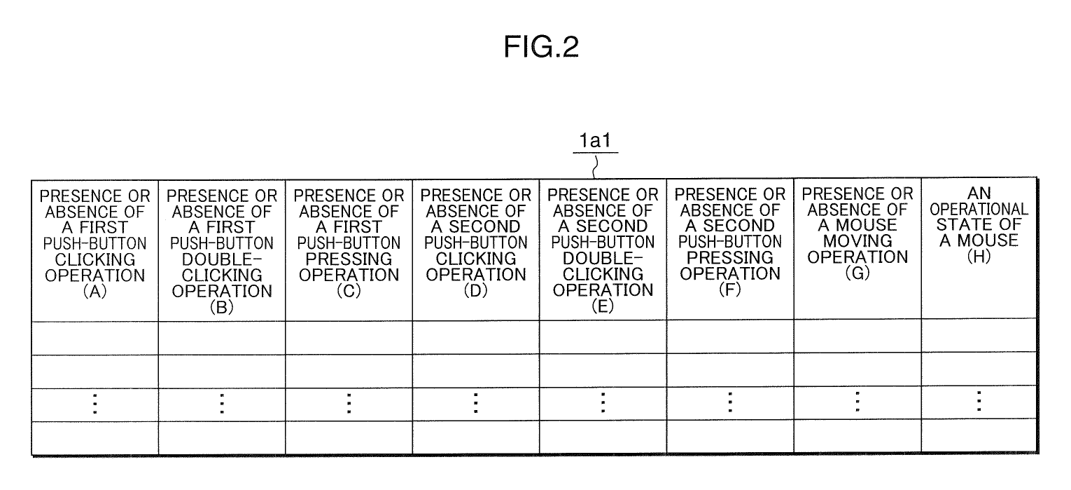

With reference to FIG. 2, the operation pattern storing memory 1a will be described. FIG. 2 schematically shows an example of an operation pattern storage table 1a1 stored in the operation pattern storing memory 1a.

The operation pattern storing memory 1a has the operation pattern storage table 1a1. As shown in FIG. 2, the operation pattern storage table 1a1 stores operation patterns of the mouse 2. The operation patterns include combinations of presence or absence of operations with respect to the first push-button 2a, presence or absence of operations with respect to the second push-button 2b, and presence or absence of a moving operation with respect to the mouse 2 detected by the movement detection sensor 2c.

The operation pattern storage table 1a1 stores presence or absence of a first push-button 2a clicking operation (a), presence or absence of a first push-button double-clicking operation (b), presence or absence of a first push-button pressing operation (c), presence or absence of a second push-button 2b clicking operation (d), presence or absence of a second push-button double-clicking operation (e), presence or absence of a second push-button pressing operation (f), presence or absence of a mouse 2 moving operation (g), and an operational state of the mouse (h). Each of the above-described items (a) through (g) includes two patterns (presence or absence) in accordance with presence or absence of a respective operation. However, for example, in the item of the operational state of the mouse (h) of the operation pattern storage table 1a1, 2⁷ operational states corresponding to all of the combinations of contents indicated by the items (a) through (g) are stored.

The file storage section 1b stores files such as image data and document data. The files stored in the file storage section 1b are displayed on a file searching window (which will be described hereinafter) on a display screen of the display device 3 under a control executed by the display controller 1i.

The input controller (an example of the instruction receiving section recited in claims of the invention) 1c receives an operation signal outputted from the mouse 2 through an operation with respect to the first push-button 2a of the mouse 2, an operation signal outputted from the mouse 2 through an operation with respect to the second push-button 2b of the mouse 2, and a movement detection signal outputted from the movement detection sensor 2c of the mouse 2, and outputs the operation signal and the movement detection signal received from the mouse 2 to the dragging operation determining section 1d.

The dragging operation determining section 1d has a function (dragging operation determination function) of determining whether or not the dragging operation is performed by a user. When the operation signal and the movement detection signal outputted from the input controller 1c is received, the dragging operation determining section 1d refers to the operation pattern storage table 1a1 stored in the operation pattern storing memory 1a in accordance with whether or not an operation signal indicating that a pressing operation is performed with respect to the first push-button 2a is received, whether or not an operation signal indicating that a pressing operation is performed with respect to the second push-button 2b is received, and whether or not a movement detection signal which is outputted from the movement detection sensor 2c is received.

Further, the dragging operation determining section 1d has a function of outputting a dragging operation continuing notice, which indicates that the dragging operation is continuously performed, to the scrolling display management section 1e at a time when it determines that the dragging operation is performed.

Furthermore, the dragging operation determining section 1d has a function of outputting a display instruction, to the display controller 1i at a time when it receives an operation signal indicating that a pressing operation is performed with respect to the second push-button 2b and determines that the clicking operation is performed with respect to the first push-button 2a. The display instruction includes an instruction of displaying on the display screen a window displaying contents of a file selected by the clicking operation (for example, a file searching window, which will be described hereinafter, including display contents such as a list of hierarchical folders and a list of hierarchical files and programs).

The scrolling display management section 1e has a function of outputting a scrolling instruction receiving area display instruction, which is an instruction to display a scrolling instruction receiving area at peripheral ends of the window, to the display controller 1i at a time when it receives the dragging operation continuing notice from the dragging operation determining section 1d. The scrolling instruction receiving area is an area for receiving from a user an instruction to scroll the display contents of the window. The scrolling instruction receiving area has a first display area for receiving an instruction to scroll the display contents of the window at a predetermined first speed, and a second display area for receiving an instruction to scroll the display contents of the window at a predetermined second speed which is different from the first speed.

Further, the scrolling display management section 1e has a function of outputting a scrolling instruction receiving area display start notice, which indicates a start of displaying a scrolling instruction receiving area at a peripheral end of the window, to the cursor position determining section 1f after outputting the scrolling instruction receiving area display instruction to the display controller 1i.

The cursor position determining section 1f has a function of outputting a transfer request of data of the display contents displayed on the screen to the display controller 1i at a time when it receives the scrolling instruction receiving area display start notice from the scrolling display management section 1e. Further, the cursor position determining section 1f has a function (cursor position determining function) of analyzing the data of the display contents displayed on the screen, which is transferred from the display controller 1i in response to the transfer request, to determine a position of a mouse cursor. Furthermore, the cursor position determining section 1f has a function of outputting the determined position information of the mouse cursor to the area determining section 1g.

The area determining section 1g has functions of (1) receiving the position information of the mouse cursor from the cursor position determining section 1f and determining whether or not the mouse cursor is within the predetermined first display area, (2) determining whether or not the mouse cursor is within the second display area at a time when it is determined that the mouse cursor is not within the first display area, (3) repeating the determinations of (1) and (2) in a case where the mouse cursor is within neither the first display area nor the second display area, and (4) outputting to the display controller 1i a mouse cursor position determination result which indicates which of the first display are, the second display area, and an area on the display screen but other than the first display area and the second display area the mouse cursor is located at.

The display area storing memory 1h stores data associated with display positions of the first display area and the second display area on the display screen, and display forms of the first display area and the second display area.

The display controller 1i has functions of receiving a display instruction to display the above-described file searching window from the dragging operation determining section 1d, reading image data for displaying the file searching window from the file storage section 1b, and allowing the display device 3 to display the file searching window on the display screen.

Further, the display controller 1i has functions (scrolling information display control function) of (a) reading a file of the file searching window, which will be described hereinafter, from the file storage section 1b, (b) reading the data associated with display positions of the first display area and the second display area on the display screen, and display forms of the first display area and the second display area from the display area storing memory 1h, (c) using the data associated with the display positions and the display form read in (b) to edit data of the file of the file searching window read in (a) and create image data of the file searching window which displays the first display area and the second display area in association with the peripheral end, and (d) allowing the display device 3 to display the created image data on the display screen in a case where the display controller 1i receives the scrolling instruction receiving area display instruction from the scrolling display management section 1e.

Further, the display controller 1i has a function (scrolling function at the first speed) of editing image data used for displaying the file searching window, and using the edited image data to display the display content on the display screen of the display device 3 in such a manner that the display content of the file searching window moves (in other words, the file searching window scrolls) at the first speed at a time when the mouse cursor position determination result received from the area determining section 1g indicates that the mouse cursor is within the first display area, and a function (scrolling function at the second speed) of editing image data used for displaying the file searching window, and using the edited image data to display the display content on the display screen of the display device 3 in such a manner that the display content of the file searching window moves (in other words, the file searching window scrolls) at the second speed at a time when the mouse cursor position determination result received from the area determining section 1g indicates that the mouse cursor is within the second display area. Here, the second speed is a predetermined speed which is different from the first speed.

Next, a user support processing will be described which is executed by the display control device 1 having the above-described configuration at a time when a user performs a drag and drop operation.

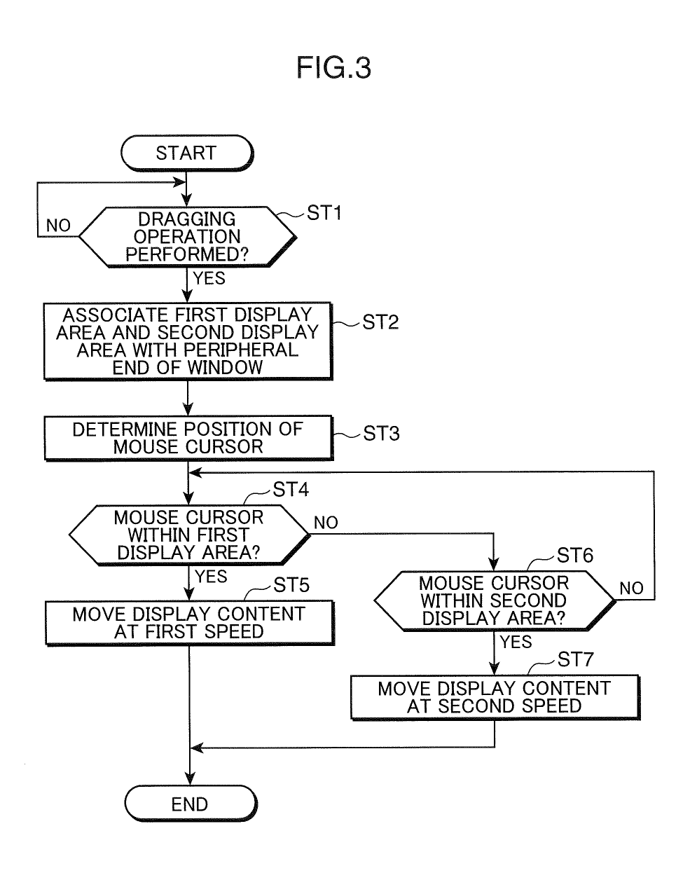

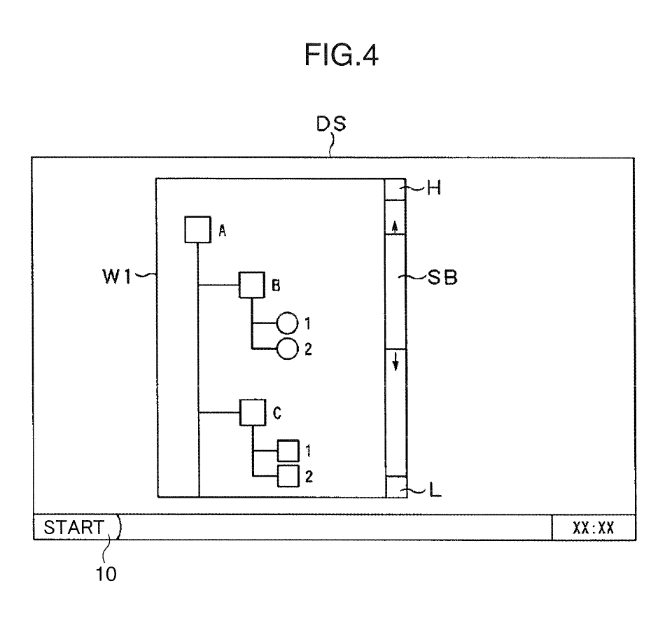

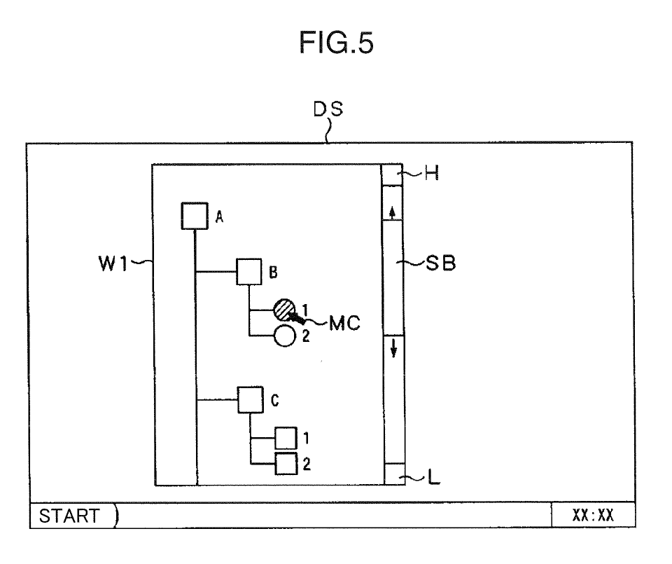

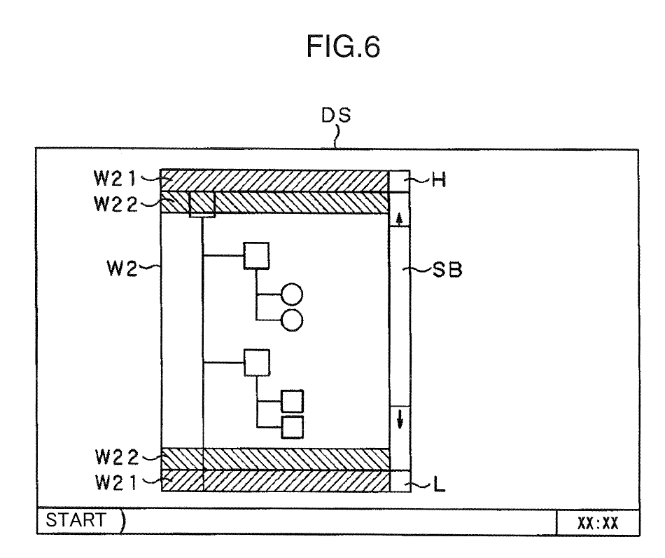

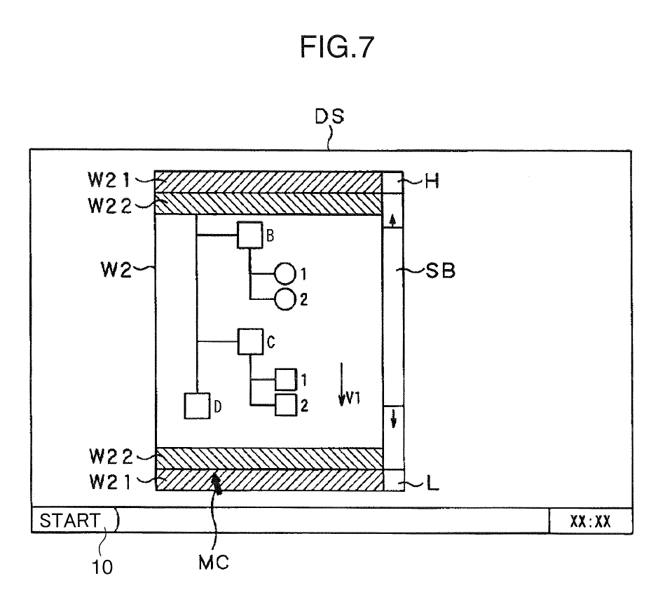

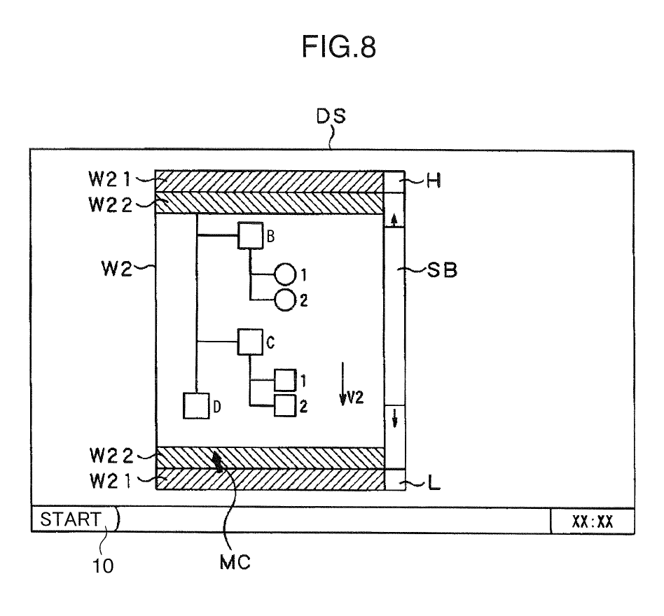

FIG. 3 is a flowchart showing the user support processing executed by the display control device 1. FIG. 4 schematically shows an example of the file searching window. FIG. 5 illustrates a relationship between an operation performed with respect to the file searching window and a determination processing executed by the dragging operation determining section. FIG. 6 schematically shows an example of the file searching window displayed on the display screen of the display device. FIG. 7 schematically shows another example of the file searching window displayed on the display screen of the display device. FIG. 8 schematically shows yet another example of the file searching window displayed on the display screen of the display device.

In the descriptions herebelow, the case where the pressing operation is performed with respect to the first push-button 2a of the mouse will be described for convenience. However, similar operation may be performed also in a case where the second push-button 2b is pressed. It should be understood that a display control program installed to the display control device 1 is automatically activated when the file searching window is displayed.

Firstly, a processing executed by the display control device 1 until the file searching window is displayed will be described briefly.

At the beginning, after a Windows (registered trademark) based OS is activated, and a start button 10 as illustrated in FIG. 4 displayed at a lower left portion of the display screen of the display device 3 is selected through a user's clicking operation performed with respect to the first push-button 2a, the display controller 1i allows an unillustrated item “program” to be displayed on the display screen of the display device 3. Next, when any one of items of the item “program” is selected through a user's moving operation performed with respect to the mouse 2, the display controller 1i allows unillustrated various menu items to be displayed on the display screen of the display device 3. Then, when an item “accessory” is selected from among the menu items through a user's moving operation performed with respect to the mouse 2, the display controller 1i allows menu items provided in a further lower layer and corresponding to items of the “accessory” to be displayed on the display screen of the display device 3.

Then, when an unillustrated “explorer” is selected from among menu items provided in the lower layer of the item “accessory” through a user's clicking operation performed with respect to the first push-button of the mouse, the display controller 1i includes a list of folders having a hierarchical structure as a display content as shown in FIG. 4 for example, and allows the display device 3 to display the file searching window W1 on the display screen. The file searching window W1 has at its right end a scrolling bar SB which is provided movably between an upper end H and a lower end L of a movable area.

In the hierarchical structure which is displayed in the file searching window W1, a □A folder belongs to a highest layer, and a □D folder which is not illustrated in FIG. 4 also belongs to the layer same as that of the □A folder. A □B folder and a □C folder belong to a layer lying under the layer to which the □A folder belongs. Further, as shown in FIG. 4, a ∘1 file and a ∘2 file belong to a layer lying under the layer to which the □B folder belongs. Furthermore, a □1 file and a □2 file belong to a layer lying under the layer to which the □C folder belongs. The hierarchical structure may be called a tree structure. The folder may be also called a directory.

It would be enough that the file searching window W1 includes one of folders, files, and programs having a hierarchical structure, and the file searching window W1 is not limited to that of the present embodiment.

Next, when the file searching window W1 is displayed on the display screen of the display device 3, the display control program installed in the display control device 1 is activated, so that the display control program executes the following user support processing.

Referring to FIG. 3 for descriptions, in step ST1, the dragging operation determining section 1d refers to the operation pattern storage table 1a1 stored in the above-described operation pattern storing memory 1a in accordance with presence or absence of an operation with respect to the first push-button 2a of the mouse 2 and presence or absence of a movement detection signal indicating detection of a moving operation with respect to the mouse 2 to determine whether or not a dragging operation is performed by a user. This step ST1 corresponds to the dragging operation determiner.

For example, as shown in FIG. 5, when a user operates the mouse 2 to move a mouse cursor MC close to the ∘1 file in the above-described file searching window W1 and designate the ∘1 file through a pressing operation with respect to the first push-button 2a of the mouse 2, and then the user moves the mouse cursor MC toward upper side or lower side in the file searching window W1 along with a movement of the mouse 2 in a horizontal direction while the user continues the pressing operation with respect to the first push-button 2a, the dragging operation determining section 1d receives the operation signal and the movement detection signal corresponding to the user's operations above and refers to the operation pattern storage table 1a1 to determine that the dragging operation is performed by the user.

In step ST2, when the dragging operation determining section 1d determines that the dragging operation is performed in the above-described step ST1 (ST1:Yes), the display controller 1i receives a scrolling instruction receiving area display instruction outputted from the scrolling display management section 1e, reads a file (image data) of the file searching window W1 from the file storage section 1b, reads data associated with display positions of the first display area and the second display area on the display screen and data associated with display forms of the first display area and the second display area from the display area storing memory 1h, uses the read data of the display positions and the display forms to edit the read data of the file of the file searching window W1, creates image data of a scrolling area clarified window W2 displaying the first display area and the second display area in association with the peripheral end, and allows the image data of the created scrolling area clarified window W2 to be displayed on the display screen of the display device 3. This step ST2 corresponds to the scrolling information display controller. Accordingly, the scrolling area clarified window W2 which will be described hereinafter is displayed on the display screen of the display device 3.

As shown in FIG. 6, in the scrolling area clarified window W2, a first display area W21 for receiving an instruction of allowing display contents of the window displayed in the scrolling area clarified window W2 to be scrolled at the predetermined first speed and a second display area W22 for receiving an instruction of allowing the display contents of the window to be scrolled at a predetermined speed which is different from the first speed are displayed at each of the upper end H and the lower end L of the above-described file searching window W1 in such a manner that display forms of those are different from one another.

In the scrolling area clarified window W2, the first display area W21 and the second display area W22 are displayed at each of the upper end H and the lower end L of the window. However, not limited to this, the display areas may be displayed at each of a right end and a left end of the window. In such case, it is so configured that display contents of the scrolling area clarified window W2 are scrolled in a lateral direction of the window at a time when a mouse cursor is moved by a user's operation with respect to the mouse 2 to any of display areas including the first display area and the second display area at the right end or the left end.

Further, not limited to the configuration in which the first display area W21 and the second display area W22 are displayed at each of the upper end H and the lower end L or at each of the right end and the left end, the first display area W21 and the second display area W22 may be provided at each of all of the peripheral ends of the scrolling area clarified window W2. In such case, it is so configured that the display content of the scrolling area clarified window W2 scrolls in a lateral direction of the window when the mouse cursor is moved by a user's operation with respect to the mouse 2 to any one of the first display area and the second display area displayed on the right end and the left end, and the display content of the scrolling area clarified window W2 scrolls upward or downward when the mouse cursor is moved by a user's operation with respect to the mouse 2 to any one of the first display area and the second display area which are displayed at the upper end H and the lower end L.

Further, in the scrolling area clarified window W2 according to the present embodiment, the first display area W21 and the second display area W22 are provided at each of the upper end H and the lower end L. However, the present invention is not limited to this. The display controller 1i may allow the first display area W21 and the second display area W22 to be displayed outside the scrolling area clarified window W2 in a form of, for example, a pop-up window.

Further, in the scrolling area clarified window W2 according to the present embodiment, the display controller 1i allows the first display area W21 and the second display area W22 to be displayed in display form different from one another. However, the present invention is not limited to this. The display controller 1i may allow the first display area W21 and the second display area W22 to be displayed in a different manner from one another in at least one of color, density, and pattern so that a user can clearly distinguish the display areas. For example, the display areas may be displayed in different colors or displayed in gradation. Further, the pattern includes a base pattern such as a hatching.

Further, in the scrolling area clarified window W2 according to the present embodiment, the first display area W21 and the second display area W22 are provided in different display forms. However, for example, the display areas may be displayed in any form as long as combinations of color and gradation can be clearly confirmed by a user.

It is preferable that the first display area W21 and the second display area W22 of the scrolling area clarified window W2 according to the present embodiment are displayed in semi-transparent colors in view of not affecting a user's scrolling operation (scrolling operation is an action of moving a cursor to an area where display contents of the window moves (corresponding to the first display areas W21 and second display areas W22) while performing a dragging operation) and the dragging operation.

On the other hand, when it is determined in the above-described step ST1 that the dragging operation is not performed (ST1:No), the dragging operation determining section 1d repeats step ST1.

In next step ST3, when the cursor position determining section 1f receives the above-described scrolling instruction receiving area display start notice from the scrolling display management section 1e, it outputs a transfer request of the data of the display content displayed on the display screen to the display controller 1i and searches the data of the display content displayed on the display screen transferred in response to the transfer request to determine a position of the mouse cursor, and then outputs determined position information of the mouse cursor to the area determining section 1g.

In next step ST4, the area determining section 1g receives from the cursor position determining section 1f the position information of the mouse cursor, and determines whether or not the position of the mouse cursor is within the first display area W21 in the above-described scrolling area clarified window W2.

When it is determined by the area determining section 1g that the mouse cursor is within the first display area in step ST4 (ST4:Yes), and the display controller 1i receives from the area determining section 1g a determination result that the mouse cursor is within the first display area in next step ST5, the display controller 1i allows displaying of the display screen of the display device 3 in such a manner that the a list of folders having a hierarchical structure, which is the display content of the above-described scrolling area clarified window W2, scrolls at the first speed toward the upper end H and the lower end L of the scrolling area clarified window W2.

Here, when the display controller 1i receives from the area determining section 1g a determination result that the mouse cursor is within the first or second display areas displayed at the upper end H of the scrolling area clarified window W2, it allows scrolling of the display screen of the display device 3 to further display a display content in an area upper than the display content which is displayed at this point of time. Further, when the display controller 1i receives from the area determining section 1g a determination result that the mouse cursor is within the first or second display areas displayed at the lower end L of the scrolling area clarified window W2, it allows scrolling of the display screen of the display device 3 to further display a display content in an area lower than the display content which is displayed at this point of time.

Accordingly, as shown in FIG. 7 for example, a list of folders having a hierarchical structure, which is a display content of the scrolling area clarified window W2, is displayed on the display screen of the display device 3 in such a manner that the list moves at a first speed v1 toward the upper end or the lower end of the scrolling area clarified window W2.

In the display control device 1 according to the present embodiment, the list of folders having a hierarchical structure, which is a display content of the scrolling area clarified window W2, moves at the first speed V1 toward the lower end of the scrolling area clarified window W2 when the mouse cursor is at the first display areas W21 of the upper end H. However, the present invention is not limited to this. It goes without saying that the list of folders may be displayed in such a manner that it moves at the first speed V1 toward the upper end of the scrolling area clarified window W2 by a user's operation of the mouse 2.

Further, in the display control device 1 according to the present embodiment, the list of folders having a hierarchical structure, which is a display content of the scrolling area clarified window W2, moves at the first speed V1 toward the upper end of the scrolling area clarified window W2 when the mouse cursor is at the first display areas W21 of the lower end L. However, the present invention is not limited to this. It goes without saying that the list of folders may be displayed in such a manner that it moves at the first speed V1 toward the lower end of the scrolling area clarified window W2 by a user's operation of the mouse 2.

On the other hand, when it is determined by the area determining section 1g in the above-described step ST4 that the mouse cursor is not within the first display area W21 (ST4:No), the area determining section 1g determines in step ST6 whether or not the position of the mouse cursor received from the cursor position determining section 1f is within the second display area W22 of the above-described scrolling area clarified window W2.

When it is determined by the area determining section 1g in the above-described step ST6 that the mouse cursor is within the second display area (ST6:Yes), and the display controller 1i receives from the area determining section 1g that the mouse cursor is within the second display area W22, the display controller 1i allows displaying of the list of folders having a hierarchical structure, which is a display content of the above-described scrolling area clarified window W2, on the display screen of the display device 3 in such a manner that the list of folders moves at the second speed toward the upper end H or the lower end L of the scrolling area clarified window W2 (ST7). Accordingly, as shown in FIG. 8 for example, the list of folders having a hierarchical structure, which is a display content of the scrolling area clarified window W2, is displayed on the display screen of the display device 3 in such a manner that the list of folders moves at a second speed v2 toward the lower end of the scrolling area clarified window W2.

On the other hand, when it is determined by the area determining section 1g in the above-described step ST5 that the mouse cursor is not within the second display area W22 (ST6:No), the processing goes back to the above-described step ST4.

Consequently, the display control device 1 according to the present embodiment terminates the executed user support processing.

According to the processing described above, a user can store the designated file (∘1 file) by scrolling a display content of the scrolling area clarified window W2 at the speed v1 or v2 while continuing the dragging operation to allow the list of folders having a hierarchical structure, which is a display content of the scrolling area clarified window W2, and dropping the file to a receiver folder (□D folder) which is not previously displayed on the scrolling area clarified window W2 but newly displayed by the scrolling as shown in FIGS. 7 and 8.

In the display control device 1 according to the present embodiment, the list of folders having a hierarchical structure, which is a display content of the scrolling area clarified window W2, moves at the second speed V2 toward the lower end of the scrolling area clarified window W2 when the mouse cursor is at the second display areas W22 of the upper end H. However, the present invention is not limited to this. It goes without saying that the list of folders may be displayed in such a manner that it moves at the second speed V2 toward the upper end of the scrolling area clarified window W2 by a user's operation of the mouse 2.

Further, in the display control device 1 according to the present embodiment, the list of folders having a hierarchical structure, which is a display content of the scrolling area clarified window W2, moves at the second speed V2 toward the upper end of the scrolling area clarified window W2 when the mouse cursor is at the second display areas W22 of the lower end L. However, the present invention is not limited to this. It goes without saying that the list of folders may be displayed in such a manner that it moves at the second speed V2 toward the lower end of the scrolling area clarified window W2 by a user's operation of the mouse 2.

Further, the case where the first speed is greater than the second speed in the display control device 1 according to the present embodiment is described above. However, the present invention is not limited to this. It goes without saying that the second speed may be greater than the first speed.

In the display control device 1 according to the present embodiment, a display content of a window which includes a list of folders having a hierarchical structure as a display content is moved toward the lower end or the upper end. However, it goes without saying that the window displayed on the display screen of the display device 3 by the display control device 1 according to the present embodiment is not limited to a window including a list of folders having a hierarchical structure as a display content.

In the present embodiment, the case where an OS (Operating System) installed to a computer is a Windows (registered trademark) based OS is described. However, any desirable OS may be selected, such as the OS of Macintosh (registered trademark), Linux, and TRON.

Further, the computer to which the display control program according to the present embodiment is a personal computer. However, the present invention is not limited to this. The computer may be a tablet type computer, a server, a PDA (Personal Digital Assistants), a mobile phone, a PHS (Personal Handyphone System), and the like.

The display control program according to the present embodiment can be created by using desirable a program language including a general high-level language, for example, C language, C#, and Delphi, an object-oriented language (C++, JAVA (registered trademark), JAVA2, Object PASCAL, Small Talk).

Further, functions of the display control program according to the present embodiment may be realized by an application program, OS, a browser, a middleware, or the like installed to the computer.

The method disclosed in the above-described embodiment can be provided to a user by storing the program as a program which can be read and executed by a computer into a recording medium such as a magnetic disk (a floppy (registered trademark) disk, a hard disk, and the like), an optical disk (CD-ROM, DVD, and the like), an optical magnetic disk (MO), a semiconductor memory, and the like and distributing the same.

Further, a method of providing the display control program according to the present invention includes, for example, a method of storing the display control program into a computer-readable recording medium and distributing the same to a user, and a method of transmitting the program to a computer owned by a user through a communication network such as the Internet and allowing the user to install the transmitted program to his computer. Further, a method of providing display control program according to the present embodiment includes a well-known method of using so-called ASP (Application Service Provider).

Further, a recording format of the recording medium associated with the present invention may be of any type as long as it is a recording medium which can store the program and can be read by a computer. For example, it may be any type including a magnetic tape, a semiconductor flash memory, a flexible disk, a CD-ROM, a CD-R/RW, a DVD-ROM, a DVD-RAM, a DVD−R/−RW, a DVD+R/+RW, an MO, and the like.

Further, the recording medium according to the present invention is not limited to the medium independent of a computer, but it may be a recording medium which stores or temporarily stores the program through a communication network such as a LAN and the Internet.

Further, according to the present invention, it goes without saying that the kind and the number of recording medium is not necessary to be one, and it may be composed of a combination of a plurality of recording mediums having the same configuration or different configurations.

The present invention is not limited to the embodiment described above. In a step of application, various modifications can be made within a range not departing from the gist of the present invention. Further, the embodiment includes various steps of invention, so that various inventions may be extracted by appropriate combinations of a plurality of disclosed elements. For example, when the invention is extracted by omitting some elements from all of the elements disclosed in the embodiment, the omitted elements are supplemented by well-known and well-used technologies at a time of practicing the extracted invention.

Other than the above, the present invention may be practiced with various modifications within the scope of the present invention.

Further, in the above-described embodiment, inventions presented as “display control device” and “display control program” from the present invention are described in view of simplifying the description. However, the present invention is not limited to this. The above-described embodiment discloses an embodiment of inventions falling in categories such as “display control method” and “recording medium” within a scope not departing from a gist of the present invention.

When the present invention is expressed as “method”, an element in each paragraph in descriptions of the invention should be replaced with “step” for understanding.

Further, when the invention is expressed as a “computer-readable recording medium”, the “display control program according to an embodiment of the present invention” should be replaced with “computer-readable recording medium storing the display control program according to the embodiment of the present invention” for understanding.

In summary, a display control device according to an aspect of the present invention includes a display control device which controls a display device to display a cursor and a window on a display screen of the display device, the display control device comprising: an instruction receiving section which receives an instruction outputted from a pointing device having a push-button and a position sensor which detects an operational change to move the cursor; a dragging operation determining section which determines based on an instruction received by the instruction receiving section whether or not a dragging operation is performed by a user; a cursor position determining section which determines a position of the cursor displayed on the display screen based on an instruction received by the instruction receiving section; and a display controller which is operable to allow the display device to display on a peripheral end of the window a scrolling instruction receiving area which receives from the user an instruction of scrolling a display content of the window when the dragging operation determining section determines that a dragging operation is performed, the display controller allowing scrolling of the display content of the window when a position of the cursor determined by the cursor position determining section is within the scrolling instruction receiving area.

According to an aspect of this invention, a display area indicating that a display content of a window scrolls is displayed in association with a peripheral end of the window. When a user allow a cursor to be positioned within the scrolling instruction receiving area by a mouse operation while performing a dragging operation, the display content of the window scrolls. Accordingly, the designated file can be stored by a dropping operation into a receiving folder which is not displayed in the window at a time when the user starts the dragging operation but newly displayed by the scrolling. Accordingly, an operability at a time of scrolling the display content of the window for a user performing the drag and drop operation can be improved.

Further, in the above-described invention, the display controller allows the display device to display a scrolling instruction receiving area including: a first display area which receives an instruction of scrolling the display content of the window at a predetermined first speed; and a second display area which receives an instruction of scrolling the display content of window at a predetermined second speed different from the first speed, and the display controller allows scrolling of the display content of the window at the first speed when a position of the cursor determined by the cursor position determining section is within the first display area, and scrolling of the display content of the window at the second speed when a position of the cursor is within the second display area.

According to an aspect of this invention, when a user allows the cursor to be positioned at the first display area or the second display area by the mouse operation while performing the dragging operation, a display content of the window can be scrolled at different speeds in accordance with at which one of the first display area and the second display area the cursor is positioned. Accordingly, an operability at a time of scrolling the display content of the window for a user performing the drag and drop operation can be improved.

Further, in the above-described invention, the display controller allows the display device to display the scrolling instruction receiving area at an upper end portion and a lower end portion of the window, the display controller allows scrolling to display a display content in an area upper than a display content which is displayed at the time when a position of the cursor determined by the cursor position determining section is within the scrolling instruction receiving area displayed at the upper end portion of the window, and the display controller allows scrolling to display a display content in an area lower than a display content which is displayed at the time when a position of the cursor determined by the cursor position determining section is within the scrolling instruction receiving area displayed at the lower end portion of the window.

Further, in the above-described invention, the display controller allows the display device to display the scrolling instruction receiving area including the first display area and the second display area at an upper portion and a lower portion of the window, the display controller allows scrolling to display a display content in an area upper than a display content which is displayed at the time when a position of the cursor determined by the cursor position determining section is within any one of the scrolling instruction receiving areas displayed at the upper end portion of the window, and the display controller allows scrolling to display a display content in an area lower than a display content which is displayed at the time when a position of the cursor determined by the cursor position determining section is within any one of the scrolling instruction receiving areas displayed at the lower end portion of the window.

Further, in the above-described invention, the display controller allows displaying of the first display area and the second display area in a different manner from each other in at least one of color, density, and pattern.

Further, a computer-readable recording medium storing a display control program according to an aspect of the present invention includes a computer-readable recording medium storing a display control program which is installed to a computer operable to execute display control for displaying a cursor and a window on a display screen of a display device, the display control program allowing the computer to serve as: an instruction receiver which receives an instruction outputted from a pointing device having a push-button and a position sensor which detects an operational change to move the cursor; a dragging operation determiner which determines based on an instruction received by the instruction receiver whether or not a dragging operation is performed by a user; a cursor position determining portion which determines a position of the cursor displayed on the display screen based on an instruction received by the instruction receiver; and a display controller which is operable to allow the display device to display on a peripheral end of the window a scrolling instruction receiving area which receives from the user an instruction of scrolling a display content of the window when the dragging operation determining section determines that a dragging operation is performed, the display controller allowing scrolling of the display content of the window when a position of the cursor determined by the cursor position determining portion is within the scrolling instruction receiving area.

Further, in the above-described invention, the display control program allows the computer to realize functions of: allowing the display controller to display the scrolling instruction receiving area including: a first display area which receives an instruction of scrolling the display content of the window at a predetermined first speed; and a second display area which receives an instruction of scrolling the display content of window at a predetermined second speed different from the first speed, and allowing the display controller to scroll the display content of the window at the first speed when a position of the cursor determined by the cursor position determining portion is within the first display area, and scroll the display content of the window at the second speed when a position of the cursor is within the second display area.

Further, in the above-described invention, the display control program allows the computer to realize functions of: allowing displaying of the scrolling instruction receiving area at an upper end portion and a lower end portion of the window; allowing scrolling to display a display content in which an area upper than a display content which is displayed at the time when a position of the cursor determined by the cursor position determining portion is within the scrolling instruction receiving area displayed at the upper end portion of the window; and allowing scrolling to display a display content in an area lower than a display content which is displayed at the time when a position of the cursor determined by the cursor position determining portion is within the scrolling instruction receiving area displayed at the lower end portion of the window.

Further, in the above-described invention, the display control program allows the computer to realize functions of: allowing displaying of the scrolling instruction receiving area including the first display area and the second display area at an upper portion and a lower portion of the window; allowing scrolling to display a display content in an area upper than a display content which is displayed at the time when a position of the cursor determined by the cursor position determining portion is within any one of the scrolling instruction receiving areas displayed at the upper end portion of the window; and allowing scrolling to display a display content in an area lower than a display content which is displayed at the time when a position of the cursor determined by the cursor position determining section is within any one of the scrolling instruction receiving areas displayed at the lower end portion of the window.

Further, in the above-described invention, the display control program allows the computer to realize a function of allowing displaying of the first display area and the second display area in a different manner from each other in at least one of color, density, and pattern.

This application is based on Japanese Patent application serial No. 2007-013045 filed in Japan Patent Office on Jan. 23, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A display control device which controls a display device to display a cursor and a window on a display screen of the display device, the display control device comprising:
an instruction receiving section which receives an instruction outputted from a pointing device having a push-button and a position sensor which detects an operational change to move the cursor;
a dragging operation determining section which determines based on an instruction received by the instruction receiving section whether or not a dragging operation is performed by a user;
a cursor position determining section which determines a position of the cursor displayed on the display screen based on an instruction received by the instruction receiving section; and
a display controller which is operable to allow the display device to display on a peripheral end of the window a scrolling instruction receiving area which receives from the user an instruction of scrolling a display content of the window when the dragging operation determining section determines that a dragging operation is performed, the display controller allowing scrolling of the display content of the window when a position of the cursor determined by the cursor position determining section is within the scrolling instruction receiving area.

2. The display control device according to claim 1, wherein
the display controller allows the display device to display a scrolling instruction receiving area including:
a first display area which receives an instruction of scrolling the display content of the window at a predetermined first speed; and
a second display area which receives an instruction of scrolling the display content of window at a predetermined second speed different from the first speed, and
the display controller allows scrolling of the display content of the window at the first speed when a position of the cursor determined by the cursor position determining section is within the first display area, and scrolling of the display content of the window at the second speed when a position of the cursor is within the second display area.

3. The display control device according to claim 1, wherein:
the display controller allows the display device to display the scrolling instruction receiving area at an upper end portion and a lower end portion of the window,
the display controller allows scrolling to display a display content in an area upper than a display content which is displayed at the time when a position of the cursor determined by the cursor position determining section is within the scrolling instruction receiving area displayed at the upper end portion of the window, and
the display controller allows scrolling to display a display content in an area lower than a display content which is displayed at the time when a position of the cursor determined by the cursor position determining section is within the scrolling instruction receiving area displayed at the lower end portion of the window.

4. The display control device according to claim 2, wherein
the display controller allows the display device to display the scrolling instruction receiving area including the first display area and the second display area at an upper portion and a lower portion of the window,
the display controller allows scrolling to display a display content in an area upper than a display content which is displayed at the time when a position of the cursor determined by the cursor position determining section is within any one of the scrolling instruction receiving areas displayed at the upper end portion of the window, and
the display controller allows scrolling to display a display content in an area lower than a display content which is displayed at the time when a position of the cursor determined by the cursor position determining section is within any one of the scrolling instruction receiving areas displayed at the lower end portion of the window.

5. The display control device according to claim 2, wherein the display controller allows displaying of the first display area and the second display area in a different manner from each other in at least one of color, density, and pattern.

6. The display control device according to claim 4, wherein the display controller allows displaying of the first display area and the second display area in a different manner from each other in at least one of color, density, and pattern.

7. A computer-readable recording medium storing a display control program which is installed to a computer operable to execute display control for displaying a cursor and a window on a display screen of a display device, the display control program allowing the computer to serve as:
an instruction receiver which receives an instruction outputted from a pointing device having a push-button and a position sensor which detects an operational change to move the cursor;
a dragging operation determiner which determines based on an instruction received by the instruction receiver whether or not a dragging operation is performed by a user;
a cursor position determining portion which determines a position of the cursor displayed on the display screen based on an instruction received by the instruction receiver; and
a display controller which is operable to allow the display device to display on a peripheral end of the window a scrolling instruction receiving area which receives from the user an instruction of scrolling a display content of the window when the dragging operation determining section determines that a dragging operation is performed, the display controller allowing scrolling of the display content of the window when a position of the cursor determined by the cursor position determining portion is within the scrolling instruction receiving area.

8. The computer-readable recording medium according to claim 7 storing the display control program, wherein the display control program allows the computer to realize functions of:
allowing the display controller to display the scrolling instruction receiving area including:
a first display area which receives an instruction of scrolling the display content of the window at a predetermined first speed; and
a second display area which receives an instruction of scrolling the display content of window at a predetermined second speed different from the first speed, and
allowing the display controller to scroll the display content of the window at the first speed when a position of the cursor determined by the cursor position determining portion is within the first display area, and scroll the display content of the window at the second speed when a position of the cursor is within the second display area.

9. The computer-readable recording medium according to claim 7 storing the display control program, wherein the display control program allows the computer to realize functions of:
allowing displaying of the scrolling instruction receiving area at an upper end portion and a lower end portion of the window;
allowing scrolling to display a display content in which an area upper than a display content which is displayed at the time when a position of the cursor determined by the cursor position determining portion is within the scrolling instruction receiving area displayed at the upper end portion of the window; and
allowing scrolling to display a display content in an area lower than a display content which is displayed at the time when a position of the cursor determined by the cursor position determining portion is within the scrolling instruction receiving area displayed at the lower end portion of the window.

10. The computer-readable recording medium according to claim 8 storing the display program, wherein the display control program allows the computer to realize functions of:
allowing displaying of the scrolling instruction receiving area including the first display area and the second display area at an upper portion and a lower portion of the window;
allowing scrolling to display a display content in an area upper than a display content which is displayed at the time when a position of the cursor determined by the cursor position determining portion is within any one of the scrolling instruction receiving areas displayed at the upper end portion of the window; and
allowing scrolling to display a display content in an area lower than a display content which is displayed at the time when a position of the cursor determined by the cursor position determining section is within any one of the scrolling instruction receiving areas displayed at the lower end portion of the window.

11. The computer-readable recording medium according to claim 8 storing the display control program, wherein the display control program allows the computer to realize a function of allowing displaying of the first display area and the second display area in a different manner from each other in at least one of color, density, and pattern.

12. The computer-readable recording medium according to claim 10 storing the display control program, wherein the display control program allows the computer to realize a function of allowing displaying of the first display area and the second display area in a different manner from each other in at least one of color, density, and pattern.
